(19) United States
(12) Patent Application Publication
(10) Pub. No.: US 2026/0004721 A1
(43) Pub. Date: Jan. 1, 2026

(54) DISPLAY DEVICE, DRIVING METHOD THEREOF, AND ELECTRONIC DEVICE INCLUDING THE SAME

(71) Applicant: Samsung Display Co., Ltd., Yongin-si (KR)

(72) Inventors: Seung Woon SHIN, Yongin-si (KR); Woon Rok JANG, Yongin-si (KR); Tae Seok HA, Yongin-si (KR)

(21) Appl. No.: 19/227,128

(22) Filed: Jun. 3, 2025

(30) Foreign Application Priority Data
Jun. 27, 2024 (KR) 10-2024-0084106

(51) Int. Cl. G09G 3/32; G09G 3/3225

(52) U.S. Cl. CPC G09G 3/32; G09G 3/3225; G09G 2320/0233; G09G 2320/0247

(57) ABSTRACT

A display device includes: a display panel including a plurality of pixels; and a display driver configured to display an image on the display panel in units of frame periods, to supply data signals corresponding to the image to the display panel during a display period of the frame period to display the image, and to not display the image during a blank period of the frame period, wherein during a blank period of one of the frame periods, the display driver is configured to supply data signals including at least one data drop waveform to the display panel.

### CROSS-REFERENCE TO RELATED APPLICATION

The present application claims priority to and the benefit of Korean Patent Application No. 10-2024-0084106, filed on Jun. 27, 2024, in the Korean Intellectual Property Office, the entire disclosure of which is incorporated herein by reference.

### BACKGROUND

### 1. Field

Aspects of some embodiments of the present disclosure relate to a display device, a driving method thereof, and electronic device including the same.

### 2. Description of the Related Art

As information technology has developed, the importance of display devices, which provide a connection medium between users and information, has been highlighted. Accordingly, the use of display devices such as a liquid crystal display devices, organic light emitting display devices, and the like has been increasing.

Recently, variable frame modes (for example, a free-sync mode, G-sync mode, and the like) have been developed, in which a processor provides data to a display device at variable frame frequencies by varying a blank period every frame period. The display device may display images in synchronization with the variable frame frequency (or a variable frame signal), that is, drive a display panel at a variable driving frequency.

However, the luminance of the display panel driven at a first driving frequency and the luminance of the display panel driven at a second driving frequency smaller than the first driving frequency may be different from each other, and thus a flicker may occur when the driving frequency of the display panel is changed.

The above information disclosed in this Background section is only for enhancement of understanding of the background and therefore the information discussed in this Background section does not necessarily constitute prior art.

### SUMMARY

Aspects of some embodiments of the present disclosure include a display device that may prevent or reduce a flicker by removing a difference in luminance that occurs when a driving frequency is changed, and a driving method thereof.

Aspects of some embodiments of the present disclosure include a display device including: a display panel including a plurality of pixels; and a display driver that displays an image on the display panel in units of frame periods, supplies data signals corresponding to the image to the display panel during a display period of the frame period to display the image, and does not display the image during a blank period of the frame period, wherein during a blank period of one of the frame periods, the display driver supplies data signals including at least one data drop waveform to the display panel.

According to some embodiments, each of the data drop waveforms may correspond to a waveform that rises in a step shape and then vertically falls.

According to some embodiments, a maximum voltage value of each of the data drop waveforms may be greater than voltage values of the data signals supplied to the display panel during the display period of the one frame period.

According to some embodiments, the number of the data drop waveforms may be determined by a length of the blank period of the one frame period.

According to some embodiments, the number of the data drop waveforms may increase as the length of the blank period in the one of the frame periods increases.

According to some embodiments, an interval between the data drop waveforms may be constant.

According to some embodiments, the interval between the data drop waveforms may constantly increase as it moves away from the display period of the one frame period.

According to some embodiments, during the one frame period, the later the data drop waveform is supplied to the display panel, the higher the maximum voltage value of the data drop waveform may be.

According to some embodiments, during the one of the frame periods, the later the data drop waveform is supplied to the display panel, the lower the maximum voltage value of the data drop waveform may be.

According to some embodiments, during the one frame period, the lower a grayscale of the image displayed on the display panel, the higher the maximum voltage value of the data drop waveforms may be.

According to some embodiments, a length of the display period when the display driver is driven at a first driving frequency and a length of the display period when the display driver is driven at a second driving frequency greater than the first driving frequency may be the same.

According to some embodiments, a length of the display period when the display driver is driven at a first driving frequency may be longer than a length of the display period when the display driver is driven at a second driving frequency greater than the first driving frequency.

According to some embodiments of the present disclosure, a driving method of a display device includes a display panel including a plurality of pixels and a display driver displaying an image on the display panel in units of frame periods, including: supplying data signals corresponding to the image to the display panel during a display period of one frame period to display the image; and supplying data signals including at least one data drop waveform to the display panel during a blank period of the one frame period.

According to some embodiments, each of the data drop waveforms may correspond to a waveform that rises in a step shape and then vertically falls.

According to some embodiments, a maximum voltage value of each of the data drop waveforms may be greater than voltage values of the data signals supplied to the display panel during the display period of the one frame period.

According to some embodiments, the number of the data drop waveforms may be determined by a length of the blank period of the one frame period.

According to some embodiments, an interval between the data drop waveforms may be constant.

According to some embodiments, the interval between the data drop waveforms may constantly increase as it moves away from the display period of the one frame period.

According to some embodiments, during the one frame period, the later the data drop waveform is supplied to the display panel, the higher the maximum voltage value of the data drop waveform may be.

According to some embodiments, during the one frame period, the lower a grayscale of the image displayed on the display panel, the higher the maximum voltage value of the data drop waveforms may be.

According to some embodiments of the present disclosure, it may be possible to provide a display device and a driving method thereof that may prevent or reduce a flicker by removing a difference in luminance that occurs when a driving frequency is changed.

The characteristics of embodiments of the present disclosure are not limited by what is described above, and more various effects are included in the present specification.

### BRIEF DESCRIPTION OF THE DRAWINGS

FIG. 1 is a drawing for explaining a display device according to some embodiments of the present disclosure.

FIG. 2 is a drawing for explaining a pixel according to some embodiments of the present invention.

FIG. 3 is a drawing for explaining a data enable signal, a vertical synchronization signal, and data signals according to a driving frequency.

FIG. 4 and FIG. 5 are drawings for explaining a method for removing a luminance difference caused by a change in a driving frequency in the display device of FIG. 1.

FIG. 6 is a drawing for explaining a method for removing a luminance difference caused by a change in a driving frequency in a display device that displays a grayscale image different from that in FIG. 5.

FIG. 7 and FIG. 8 illustrate embodiments of the display device of FIG. 1.

FIG. 9 and FIG. 10 illustrate other embodiments of the display device of FIG. 1.

FIG. 11 illustrates a flowchart of a method for removing a luminance difference caused by a change in a driving frequency of the display device of FIG. 1.

FIG. 12 is a block diagram of an electronic device according to an embodiment.

FIG. 13 shows schematic views of various embodiments of an electronic device.

### DETAILED DESCRIPTION

Hereinafter, aspects of some embodiments of the present disclosure will be described in more detail with reference to the accompanying drawings. The following description is intended to provide only a sufficient disclosure to enable the understanding of the operation of the invention, and any other disclosure is omitted to avoid obscuring the scope of the invention. In addition, embodiments according to the present disclosure may be embodied in different forms and is not limited to the embodiments set forth herein. The embodiments described herein are provided for the purpose of describing the technical concept of the invention in sufficient detail for those skilled in the art to easily practice it.

Throughout the specification, when it is described that an element is “connected” to another element, this includes not only being “directly connected”, but also being “indirectly connected” with another device in between. The terms used herein are for the purpose of describing specific embodiments and are not intended to limit the scope of the invention. Throughout the specification, unless explicitly described to the contrary, the word “comprise” and variations such as “comprises” or “comprising” will be understood to imply the inclusion of stated elements but not the exclusion of any other elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms first, second, etc. may be used herein to describe various constituent elements, these constituent elements should not be limited by these terms. These terms are used to distinguish one constituent element from another. Thus, a first constituent element discussed below could be termed a second constituent element without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (for example, rotated 90 degrees or at other orientations), and, as such, the spatially relative descriptors used herein interpreted accordingly.

Various embodiments are described herein with reference to sectional illustrations that are schematic illustrations of idealized embodiments. As such, variations from the shapes of the illustrations as a result, for example, of manufacturing techniques and/or tolerances, are to be expected. Thus, embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

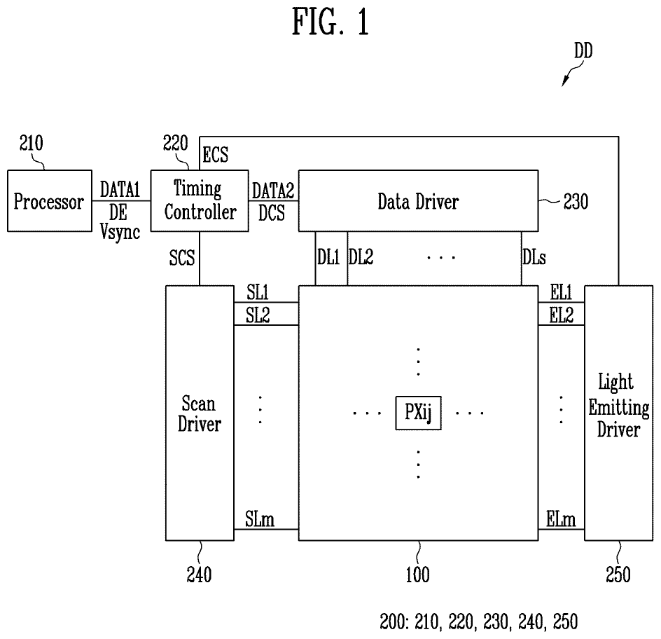

FIG. 1 is a drawing for explaining a display device according to some embodiments of the present disclosure.

Referring to FIG. 1, a display device DD according to some embodiments of the present disclosure may include a display panel 100 and a display driver 200. The display driver 200 may include a processor 210, a timing controller 220, a data driver 230, a scan driver 240, and a light emitting driver 250. According to various embodiments, the display device DD may be incorporated into or utilized as part of electronic device, such as a television, a computer monitor, a laptop computer, a tablet computer, a smartphone, a wearable electronic device (e.g., an augmented reality device, a virtual reality device, a smartwatch, etc.) and the like.

The display panel 100 may display images in response to a variable driving frequency. The driving frequency is a frequency at which data voltages (or data signals DATA) are written (or substantially written) to a driving transistor of a pixel per second. For example, the driving frequency is also referred to as a screen refresh rate, and represent a frequency at which an image is played per second.

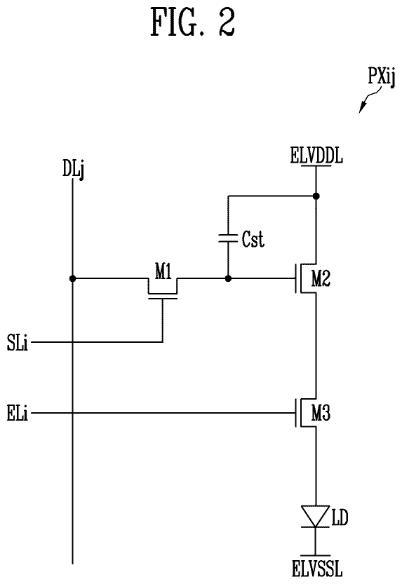

The display panel 100 may include pixels. Each pixel Pxij may be connected to data and scan lines corresponding thereto (where include and j are integers greater than 0). The pixel Pxij may mean a pixel in which a scan transistor is connected to an i-th scan line and a j-th data line. Specific details of the pixel Pxij will be described in more detail later with reference to FIG. 2.

The processor 210 may be configured of a graphics processing unit (GPU), a central processing unit (CPU), an application processor (AP), or the like. The processor 210 may refer to an integrated chip (IC) or a group configured of a plurality of Ics.

The processor 210 may supply a timing control signal and a first image data DATA1 to the timing controller 220.

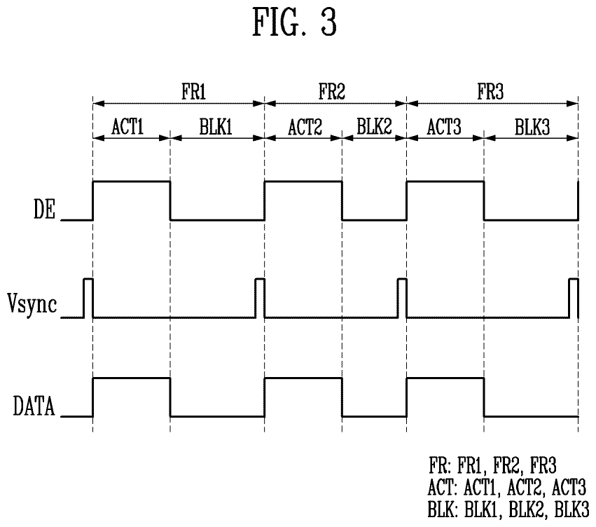

The timing control signal may include a data enable signal DE, an vertical synchronization signal Vsync, and the like. The vertical synchronization signal Vsync may define frame periods FR (see FIG. 3). The vertical synchronization signal Vsync may include a high-level period and a low-level period. The period of the vertical synchronization signal Vsync may vary depending on the driving frequency. For example, as the driving frequency increases, the period of the vertical synchronization signal Vsync may decrease. For example, as the driving frequency decreases, the period of the vertical synchronization signal Vsync may increase.

Each frame period FR may start at a time point when the vertical synchronization signal Vsync transitions from a high level to a low level.

The data enable signal DE may define a blank period BLK (see FIG. 3) and a display period ACT (see FIG. 3) included in each of the frame periods FR. For example, the data enable signal DE may have a high level during the display periods ACT and a low level during the blank period BLK.

During a period in which the data enable signal DE maintains the high level, the data signals DATA may be outputted from the data driver 230.

Image may be displayed on the display panel 100 in units of the frame period FR. For example, the images may be displayed by supplying data signals DATA corresponding to the image to the display panel 100 during the display period ACT of the frame period FR. In addition, the display panel 100 may not display the image during the blank period BLK of the frame period FR.

The timing controller 220 may receive the vertical synchronization signal Vsync, the data enable signal DE, and the first image data DATA1 from the processor 210. The timing controller 220 may supply control signals to each of the data driver 230, the scan driver 240, and the light emitting driver 250 based on the signals supplied from the processor 210. For example, the timing controller 220 may supply a data control signal DCS to the data driver 230. The timing controller 220 may supply a scan control signal SCS to the scan driver 240. The timing controller 220 may supply a light emitting control signal ECS to the light emitting driver 250.

In addition, the timing controller 220 may convert the first image data DATA1 inputted from the processor 210 into second image data DATA2 that meets the specifications of the data driver 230 to supply it to the data driver 230.

The data driver 40 may generate the data signals DATA to be supplied to the display panel 100 by using the second image data DATA2 and the data control signal DCS.

The scan driver 240 may receive the scan control signal SCS and the like from the timing controller 220 to generate scan signals to be provided to scan lines SL1 to SLm (where m is an integer greater than 0).

The scan driver 240 may sequentially supply scan signals having a turn-on level pulse to the scan lines SL1 to SLm. The scan driver 240 may include scan stages configured in a form of a shift register. The scan driver 240 may generate the scan signals through a method of sequentially transmitting a scan start signal, which is a pulse type of a turn-on level, to a next scan stage.

The light emitting driver 250 may receive the light emitting control signal ECS and the like from the timing controller 220 to generate light emitting signals to be provided to light emitting lines EL1 to Elm (where m is an integer greater than 0). For example, the light emitting driver 250 may include light emitting stages connected to the light emitting lines EL1 to Elm. The light emitting stages may be configured in the form of a shift register. For example, a first light emitting stage may generate a light emitting signal of a turn-off level based on a light emitting stop signal of a turn-off level, and the remaining light emitting stages may sequentially generate light emitting signals of a turn-off level based on a light emitting signal of a turn-off level of a previous light emitting stage.

FIG. 2 is a drawing for explaining a pixel according to some embodiments of the present invention. Although FIG. 2 illustrates various components in a pixel according to some embodiments, embodiments according to the present disclosure are not limited thereto, and according to some embodiments, the pixel may include additional components or fewer components without departing from the spirit and scope of embodiments according to the present disclosure.

Referring to FIG. 2, the pixel Pxij may include transistors M1, M2, and M3, a storage capacitor Cst, and a light emitting diode LD.

Hereinafter, a circuit configured of an N-type transistor will be described as an example. However, those skilled in the art will be able to design a circuit configured of a P-type of transistor by varying a polarity of a voltage applied to a gate terminal. Similarly, a person of an ordinary skill in the art would be able to design a circuit configured of a combination of a P-type of transistor and an N-type of transistor. A P-type transistor refers to a transistor in which an amount of current that is conducted when a voltage difference between a gate terminal and a source terminal increases in a negative direction increases. An N-type transistor refers to a transistor in which an amount of current that is conducted when a voltage difference between a gate terminal and a source terminal increases in a positive direction increases. The transistor may have various kinds such as a thin film transistor (TFT), a field effect transistor (FET), and a bipolar junction transistor (BJT).

A first transistor M1 may have a gate electrode connected to an include-th scan line Sli, a first electrode connected to a j-th data line DLj, and a second electrode connected to a gate electrode of a second transistor M2. The first transistor M1 may be referred to as a scan transistor.

The second transistor M2 may have a gate electrode connected to a first electrode of the storage capacitor Cst, a first electrode connected to a first power line ELVDDL, and a second electrode connected to a first electrode of a third transistor M3. The second transistor M2 may be referred to as a driving transistor.

The third transistor M3 may have a gate electrode connected to an i-th light emitting line Eli, a first electrode connected to the second electrode of the second transistor M2, and a second electrode connected to an anode of the light emitting diode LD. The third transistor M3 may be referred to as a control transistor.

A first electrode of the storage capacitor Cst may be connected to the gate electrode of the second transistor M2, and a second electrode thereof may be connected to the first electrode of the second transistor M2.

The anode of the light emitting diode LD may be connected to the second electrode of the third transistor M3, and a cathode thereof may be connected to the second power line ELVSSL. The light emitting diode LD may include an organic light emitting diode, an inorganic light emitting diode, and a quantum dot/well light emitting diode. Meanwhile, the pixel Pxij of FIG. 2 is illustrated to include one light emitting diode LD as an example, but according to some embodiments, the pixel Pxij may include a plurality of light emitting diodes connected in series, parallel, or series-parallel.

A first power voltage may be applied to the first power line ELVDDL, and a second power voltage may be applied to the second power line ELVSSL. For example, during the display period ACT, the first power voltage may be larger than the second power voltage.

When a scan signal having a turn-on level (here, a logic low level) is applied through the scan line Sli, the first transistor M4 is turned on. In this case, the data voltage applied to the data line DLj is stored in the first electrode of the storage capacitor Cst. In this case, a light emitting signal of a turn-off level (here, a logic low level) is applied through the light emitting line Eli, and the third transistor M3 is turned off.

Thereafter, a light emitting signal of a turn-on level (here, a logic high level) is applied through the light emitting line Eli, and the third transistor M3 is turned on. Accordingly, a positive driving current corresponding to the voltage difference between the first electrode and the second electrode of the storage capacitor Cst flows between the first electrode and the second electrode of the second transistor M2. As a result, the light emitting diode LD emits light with luminance corresponding to data voltages (or the data signals DATA).

Next, when a scan signal of a turn-off level (here, a logic low level) is applied through the scan line Sli, the first transistor M1 is turned off, and the data line DLj and the first electrode of the storage capacitor Cst are electrically separated. Accordingly, even if the data voltages (or the data signals DATA) of the data line DLj are changed, the voltage stored in the first electrode of the storage capacitor Cst is not changed.

The embodiments are not limited to the pixel Pxij of FIG. 2, and may be applied to pixels of other pixel circuits.

FIG. 3 is a drawing for explaining a data enable signal, a vertical synchronization signal, and data signals according to a driving frequency.

Referring to FIG. 3, the data enable signal DE may include the display period ACT and the blank period BLK within the frame period FR.

The frame periods FR may include first to third frame periods FR1 to FR3. The first frame period FR1 may include a first display period ACT1 and a first blank period BLK1. The second frame period FR2 may include a second display period ACT2 and a second blank period BLK2. The third frame period FR3 may include a third display period ACT3 and a third blank period BLK3.

The vertical synchronization signal Vsync may include a high-level period and a low-level period. The period of the vertical synchronization signal Vsync may vary depending on the driving frequency. For example, as the driving frequency increases, the period of the vertical synchronization signal Vsync may decrease. For example, as the driving frequency decreases, the period of the vertical synchronization signal Vsync may increase.

The frame period FR may start at a time point when the vertical synchronization signal Vsync transitions from a high level to a low level. For example, each of the first to third frame periods FR1 to FR3 may start at a time point when the vertical synchronization signal Vsync transitions to a low level.

The data enable signal DE may define the blank period BLK and the display period ACT included in each of the frame periods FR. The data enable signal DE may have a high level during the display period ACT and a low level during the blank period BLK. For example, the data enable signal DE may have a high level during the first to third display periods ACT1 to ACT3. The data enable signal DE may have a low level during the first to third blank periods BLK1 to BLK3.

During a period in which the data enable signal DE maintains the high level, the data signals DATA may be outputted from the data driver 230. For example, the data signals DATA may be outputted from the display driver 200 during the first to third display periods ACT1 to ACT3.

During a period in which the data enable signal DE maintains the low level, new data signals DATA may not be outputted from the data driver 230. For example, new data signals DATA may not be outputted during the first to third blank periods BLK1 to BLK3.

The blank period BLK may correspond to a light emitting period in which a pixel emits light according to data signals DATA written in the display period ACT. For example, the first blank period BLK1 may correspond to a light emitting period in which a pixel emits light according to data signals DATA written in the first display period ACT1.

In FIG. 3, it is assumed that the first frame period FR1 and the third frame period FR3 are each driven at a driving frequency of 30 Hz. In addition, it is assumed that the second frame period FR2 is driven at a driving frequency of 60 Hz. However, embodiments of the present disclosure are not necessarily limited thereto.

The length of the display period ACT may be the same (or substantially the same) regardless of the driving frequency. For example, the lengths of the first to third display periods ACT1 to ACT3 may be the same (or substantially the same).

On the other hand, the length of the blank period BLK may vary depending on the driving frequency. As the driving frequency of the frame period FR increases, the length of the blank period BLK may decrease. For example, in FIG. 3, the lengths of the first and third blank periods BLK1 and BLK3 may be longer than the length of the second blank period BLK2.

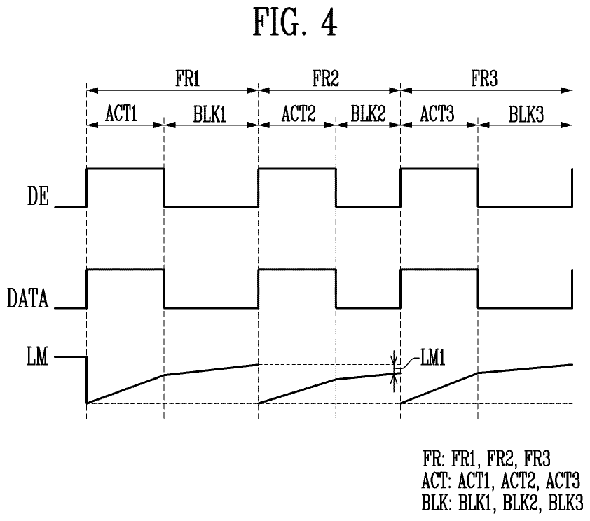

Depending on the difference between these blank periods BLK, a difference in luminance may occur when the driving frequency is changed. For example, when the driving frequency of the frame period decreases, a difference in luminance LM may occur as the blank period BLK, that is, the light emitting period, increases and the luminance LM (see FIG. 4) increases. In addition, when the driving frequency of the frame period increases, a difference in luminance LM may occur as the blank period BLK, that is, the light emitting period, decreases and the luminance LM decreases. This will be described later in detail with reference to FIG. 4.

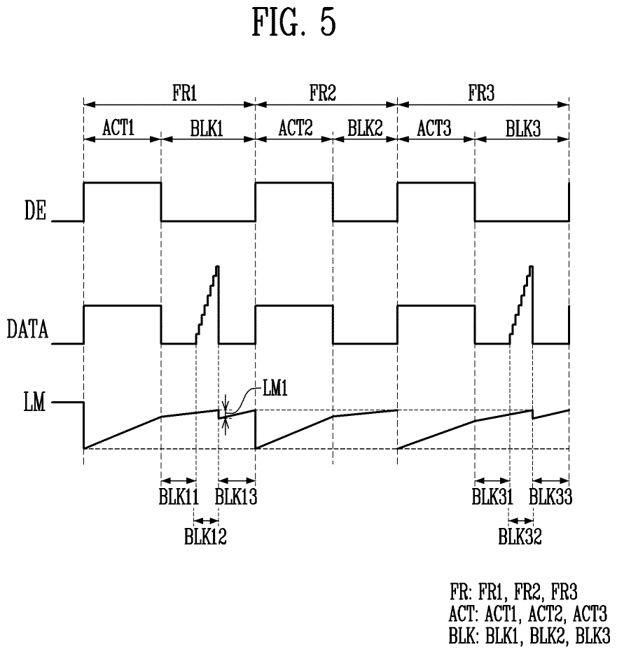

FIG. 4 and FIG. 5 are drawings for explaining a method for removing a luminance difference caused by a change in a driving frequency in the display device of FIG. 1.

Referring to FIG. 4, the frame periods FR may include first to third frame periods FR1 to FR3. The display periods ACT may include first to third display periods ACT1 to ACT3. The blank periods BLK may include first to third blank periods BLK1 to BLK3.

During the display period ACT, the luminance LM may increase due to the supplied data voltages DATA. During the blank period BLK, the luminance LM may increase due to the previously supplied data voltages DATA. During the blank period BLK, the luminance LM may gradually increase compared to the display period ACT.

Each of the first frame period FR1 and the third frame period FR3 is a period that is driven at a driving frequency of 30 Hz. The second frame period FR2 is a period driven at a driving frequency of 60 Hz.

Unlike the first frame period FR1, the driving frequency may be high during the second frame period FR2. The second blank period BLK2 may be shorter than the first blank period BLK1. During the second frame period FR2, the light emitting period is shortened, which may result in a difference in luminance LM compared to the first frame period FR1. For example, there may be a difference by the first luminance LM1 between the luminance at the end of the first frame period FR1 and the luminance at the end of the second frame period FR2. In addition, this difference in luminance, which occurs when the driving frequency is changed, may cause a flicker.

Unlike the second frame period FR2, the driving frequency may be low during the third frame period FR2. The third blank period BLK3 may be longer than the second blank period BLK2. During the third frame period FR3, the light emitting period increases, which may result in a difference in luminance LM compared to the second frame period FR2. For example, there may be a difference by the first luminance LM1 between the luminance at the end of the third frame period FR3 and the luminance at the end of the second frame period FR2. In addition, this difference in luminance, which occurs when the driving frequency is changed, may cause a flicker.

Referring to FIG. 5, the first blank period BLK1 may include eleventh to thirteenth blank periods BLK11 to BLK13. The third blank period BLK3 may include thirty-first to thirty-third blank periods BLK31 to BLK33.

In the display device DD according to some embodiments of the present disclosure, the display driver 200 may supply the data signals DATA to the display panel 100 during the blank period BLK of at least one frame period FR. More specifically, the display driver 200 may supply data signals DATA including at least one data drop waveform to the display panel 100 during the blank period BLK of at least one frame period FR. According to some embodiments of the present disclosure, the data drop waveform may correspond to a waveform that rises in a step shape and then falls vertically. For example, as shown in FIG. 5, in the first blank period BLK1 and the third blank period BLK3, the display driver 200 may supply the data signals DATA including the data drop waveforms to the display panel 100.

The data signals DATA including the data drop waveform may be supplied to the display panel 100 during the blank period BLK of one frame period FR. In this case, the maximum voltage value of the data drop waveform may be greater than the voltage value of the data signals DATA supplied during the display period ACT of the one frame period FR. For example, the maximum voltage value of the data drop waveform supplied during the twelfth blank period BLK12 may be greater than the voltage value of the data signals DATA supplied during the first display period ACT1. For example, the maximum voltage value of the data drop waveform supplied during the thirty-second blank period BLK32 may be greater than the voltage value of the data signals DATA supplied during the third display period ACT3.

When the data voltages DATA of the data drop waveform are supplied during the blank period BLK, a coupling phenomenon may occur between the pixel Pxij and the data line DLj. For example, when data voltages DATA that rise during the blank period BLK are supplied, the luminance LM during the blank period BLK may rise more steeply. On the other hand, when data voltages DATA that fall during the blank period BLK are supplied, the increase in the luminance LM during the blank period BLK may be gradual. Alternatively, when data voltages DATA that fall during the blank period BLK are supplied, the luminance LM during the blank period BLK may fall.

In the blank period BLK, when the data voltages DATA of the data drop waveform that rise in a step shape and then fall vertically are supplied to the display panel 100, the change in luminance LM is as follows.

In a period in which a data drop waveform that gradually rises in a step shape is supplied, a coupling phenomenon between the pixel Pxij and the data line DLj may be minimized. In addition, a change in the rising slope of the luminance LM during the blank period BLK may be minimized. For example, the rising slope of the luminance LM in the twelfth blank period BLK12 may not be significantly different from the rising slope of the luminance LM in the eleventh and thirteenth blank periods BLK11 and BLK13. For example, the rising slope of the luminance LM in the thirty-second blank period BLK32 may not be significantly different from the rising slope of the luminance LM in the thirty-first and thirty-third blank periods BLK31 and BLK33.

In a period in which a rapidly vertically falling data drop waveform is supplied, a coupling phenomenon between the pixel Pxij and the data line DLj may be maximized. For example, in the period in which the rapidly vertically falling data drop waveform is supplied, the luminance LM at the end of the twelfth blank period BLK12 may fall vertically by the first luminance LM1. For example, in the period in which the rapidly vertically falling data drop waveform is supplied, the luminance LM at the end of the thirty-second blank period BLK32 may fall vertically by the first luminance LM1. Accordingly, the luminance LM at the end of the first blank period BLK1 and the luminance LM at the end of the second blank period BLK2 may be the same (or substantially the same). Similarly, the luminance LM at the end of the second blank period BLK2 and the luminance LM at the end of the third blank period BLK3 may be the same (or substantially the same).

The display device DD according to some embodiments of the present disclosure may supply the data voltages DATA including the data drop waveform in at least one blank period BLK. Accordingly, the luminance LM in the frame period FR in which the driving frequency is low is reduced, so that the difference in the luminance LM existing between respective frame periods FR may be removed. In addition, when the driving frequency is changed, flicker caused by differences in luminance LM may be removed or reduced.

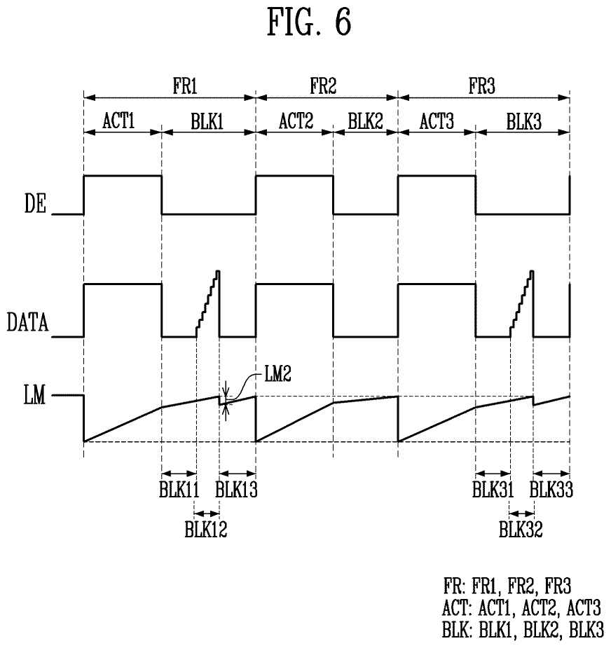

FIG. 6 is a drawing for explaining a method for removing a luminance difference caused by a change in a driving frequency in a display device that displays a grayscale image different from that in FIG. 5.

Referring to FIG. 4 to FIG. 6, the frame periods FR may include first to third frame periods FR1 to FR3. The display periods ACT may include first to third display periods ACT1 to ACT3. The blank periods BLK may include first to third blank periods BLK1 to BLK3.

The first blank period BLK1 may include eleventh to thirteenth blank periods BLK11 to BLK13. The third blank period BLK3 may include thirty-first to thirty-third blank periods BLK31 to BLK33. Descriptions that are redundant with FIG. 5, except for the data voltages DATA supplied to the display panel 100 and the resulting change in luminance LM, will be omitted below.

The higher the grayscale of the data voltages DATA supplied during the display period ACT, the greater the rising slope of the luminance LM in the display period ACT. Compared to FIG. 5, FIG. 6 may be a case in which higher grayscale data voltages DATA are supplied during the display period ACT. Accordingly, the rising slope of the luminance LM in the display period ACT of FIG. 6 may be greater than the rising slope of the luminance LM in the display period ACT of FIG. 5.

When the grayscale of the data voltages DATA supplied during the display period ACT is high, the luminance LM may reach closer to a target luminance even in the frame period FR in which the length of the blank period BLK is short. For example, the luminance LM in the second frame period FR2 of FIG. 6 may reach the target luminance LM closer than the luminance LM in the second frame period FR2 of FIG. 5. Accordingly, in FIG. 6, the difference in luminance LM between the first and second frame periods FR1 and FR2 may be the second luminance LM2 smaller than the first luminance LM1.

As the maximum voltage value of the data drop waveforms is lower, the reduction amount of the luminance LM may be reduced. In FIG. 6, unlike in FIG. 5, the reduction amount of the luminance LM required in the frame period FR in which the driving frequency is low may be small. Accordingly, even if the maximum voltage value of the data drop waveforms is smaller in FIG. 6 than in FIG. 5, the difference in luminance LM between the frame periods FR may be removed. Accordingly, the flicker may be removed.

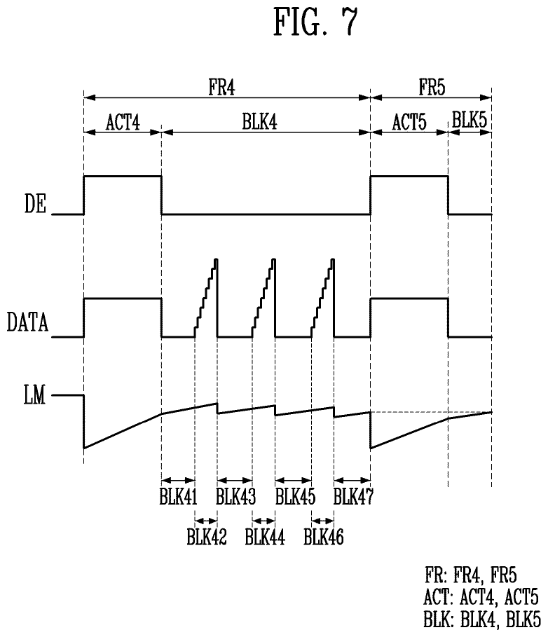

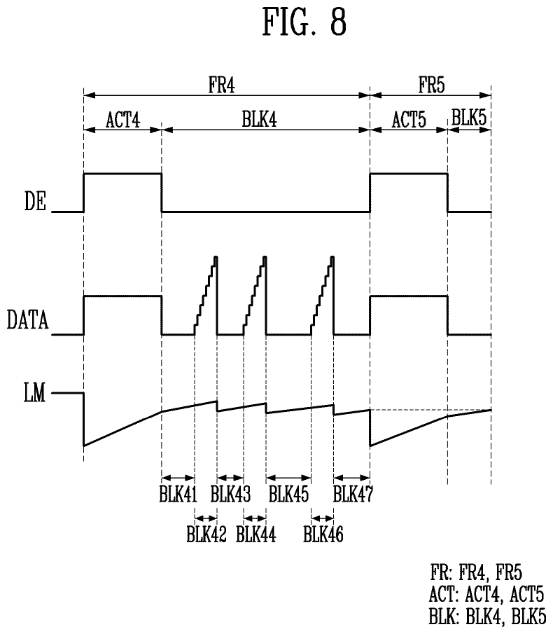

FIG. 7 and FIG. 8 illustrate embodiments of the display device of FIG. 1.

Referring to FIG. 7 and FIG. 8, the frame periods FR may include fourth and fifth frame periods FR4 and FR5. The fourth frame period FR4 may include a fourth display period ACT4 and a fourth blank period BLK4. The fifth frame period FR5 may include a fifth display period ACT5 and a fifth blank period BLK5. In addition, the fourth blank period BLK4 may include forty-first to forty-seventh blank periods BLK41 to BLK47.

For the description of the embodiments shown in FIG. 7 and FIG. 8, the driving frequency of the fourth frame period FR4 may be smaller than the driving frequency of the first frame period FR1 of FIG. 5 and FIG. 6. In addition, the driving frequency of the fifth frame period FR5 may be greater than the driving frequency of the second frame period FR2 of FIG. 5 and FIG. 6. Hereinafter, it will be assumed and described that the fourth frame period FR4 has a driving frequency of 10 Hz and the fifth frame period FR5 has a driving frequency of 70 Hz.

Data voltages DATA including at least one data drop waveform may be supplied during a blank period of one frame period. In this case, the number of data drop waveforms may be determined according to a length of the blank period of the one frame period. For example, the number of data drop waveforms may increase as the length of the blank period of the one frame period increases.

Referring to FIG. 5 to FIG. 8, the length of the fourth blank period BLK4 may be longer than the length of the first blank period BLK1. The increase in the luminance LM in the fourth blank period BLK4 may be greater than the increase in the luminance LM in the first blank period BLK1. In addition, the length of the fifth blank period BLK5 may be shorter than the length of the second blank period BLK2. The increase in the luminance LM in the fifth blank period BLK5 may be smaller than the increase in the luminance LM in the second blank period BLK2. In other words, the difference in luminance LM between the fourth blank period BLK4 and the fifth blank period BLK5 may be greater than the difference in luminance LM between the first blank period BLK1 and the second blank period BLK2.

In order to prevent or reduce a flicker, the reduction amount of the luminance LM required in the fourth blank period BLK4 may be greater than the reduction amount of the luminance LM required in the first blank period BLK1. To this end, the number of data drop waveforms supplied during the fourth blank period BLK4 may be greater than the number of data drop waveforms supplied during the first blank period BLK1. For example, data voltages DATA including data drop waveforms may be supplied during the forty-second blank period BLK42, the forty-fourth blank period BLK44, and the forty-sixth blank period BLK46.

In this case, the interval between the data drop waveforms may be the same (or substantially the same) as shown in FIG. 7. Alternatively, the interval between the data drop waveforms may gradually increase (for example, uniformly increase) as shown in FIG. 8. Alternatively, the interval between the data drop waveforms May gradually decrease (for example, uniformly decrease). In this case, the maximum voltage values of the data drop waveforms may be the same (or substantially the same).

As described above, the display device DD may adjust the reduction amount of the luminance LM by adjusting the number of data drop waveforms. Accordingly, the display device DD may remove the occurrence of a flicker.

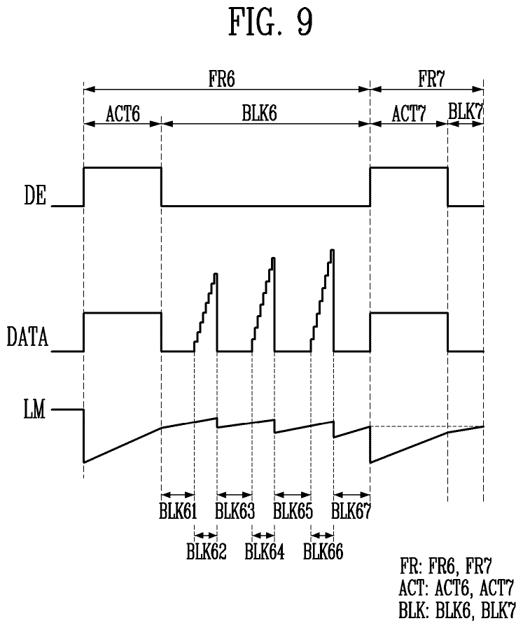

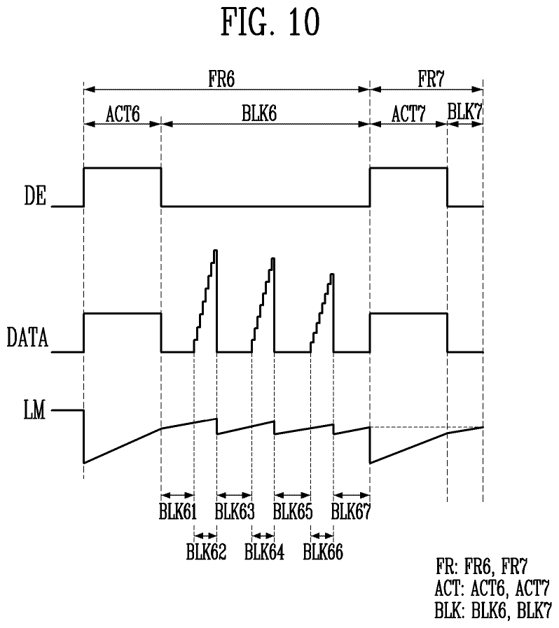

FIG. 9 and FIG. 10 illustrate other embodiments of the display device of FIG. 1.

Referring to FIG. 9 and FIG. 10, the frame periods FR may include sixth and seventh frame periods FR6 and FR7. The sixth frame period FR6 may include a sixth display period ACT6 and a sixth blank period BLK6. The seventh frame period FR7 may include a seventh display period ACT7 and a seventh blank period BLK7. In addition, the sixth blank period BLK6 may include sixty-first to sixty-seventh blank periods BLK61 to BLK67.

For the description of the embodiments shown in FIG. 9 and FIG. 10, the driving frequency of the sixth frame period FR6 may be the same (or substantially the same) as the driving frequency of the fourth frame period FR4 of FIG. 7 and FIG. 8. In addition, the driving frequency of the seventh frame period FR7 may be greater than the driving frequency of the fifth frame period FR5 of FIG. 7 and FIG. 8. Hereinafter, it will be assumed and described that the sixth frame period FR6 has a driving frequency of 10 Hz and the seventh frame period FR7 has a driving frequency of 120 Hz.

Referring to FIG. 7 to FIG. 10, the length of the sixth blank period BLK6 may be the same (or substantially the same) as the length of the fourth blank period BLK4. The increase in the luminance LM in the sixth blank period BLK6 may be the same (or substantially the same) as the increase in the luminance LM in the fourth blank period BLK4. In addition, the length of the seventh blank period BLK7 may be shorter than the length of the fifth blank period BLK5. The increase in the luminance LM in the seventh blank period BLK7 may be smaller than the increase in the luminance LM in the fifth blank period BLK5. In other words, the difference in luminance LM between the seventh blank period BLK7 and the sixth blank period BLK6 may be greater than the difference in luminance LM between the fifth blank period BLK5 and the fourth blank period BLK4.

In order to prevent or reduce a flicker, the reduction amount of the luminance LM required in the sixth blank period BLK6 may be greater than the reduction amount of the luminance LM required in the fourth blank period BLK4. To this end, as shown in FIG. 9, the maximum voltage value of the data drop waveforms supplied during the sixth blank period BLK6 may be set to be higher for data drop waveforms supplied later. Alternatively, as shown in FIG. 10, the maximum voltage values of the data drop waveforms supplied during the sixth blank period BLK6 may be set to be lower as the data drop waveforms supplied later are supplied.

As described above, even if the number of data drop waveforms is the same, the display device DD may adjust the reduction amount of the luminance LM by adjusting the maximum voltage values of the data drop waveforms. Accordingly, the display device DD may remove the occurrence of a flicker.

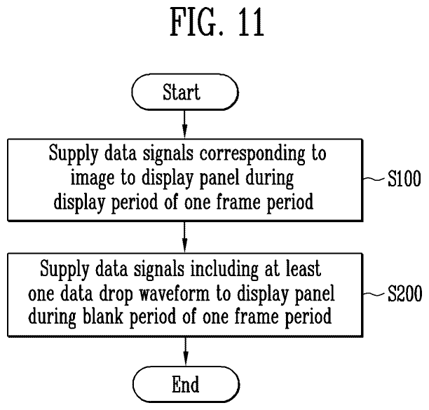

FIG. 11 is a flowchart illustrating aspects of a method for removing a luminance difference caused by a change in a driving frequency of the display device of FIG. 1. Although FIG. 11 illustrates various operations in a method for removing a luminance difference, embodiments according to the present disclosure are not limited thereto, and according to various embodiments, the method may include additional operations or fewer operations without departing from the spirit and scope of embodiments according to the present disclosure.

Referring to FIG. 1 to FIG. 11, in operation S100, data signals DATA corresponding to an image may be supplied to the display panel 100 during the display period ACT of one frame period FR.

In operation S200, the data signals DATA including at least one data drop waveform may be supplied to the display panel 100 during the blank period BLK of the one frame period FR.

A display device according to an embodiment is applicable to various types of electronic devices. In an embodiment, an electronic device includes the above-described display device and may further include other modules or devices having additional functions in addition to the display device.

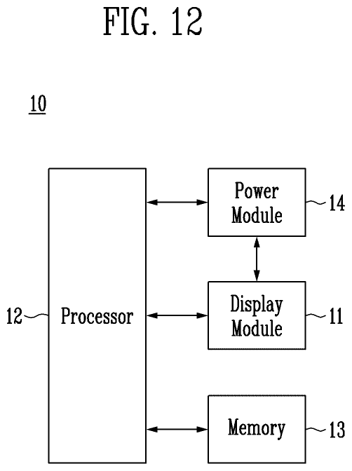

FIG. 12 is a block diagram of an electronic device according to an embodiment. Referring to FIG. 12, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller. The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

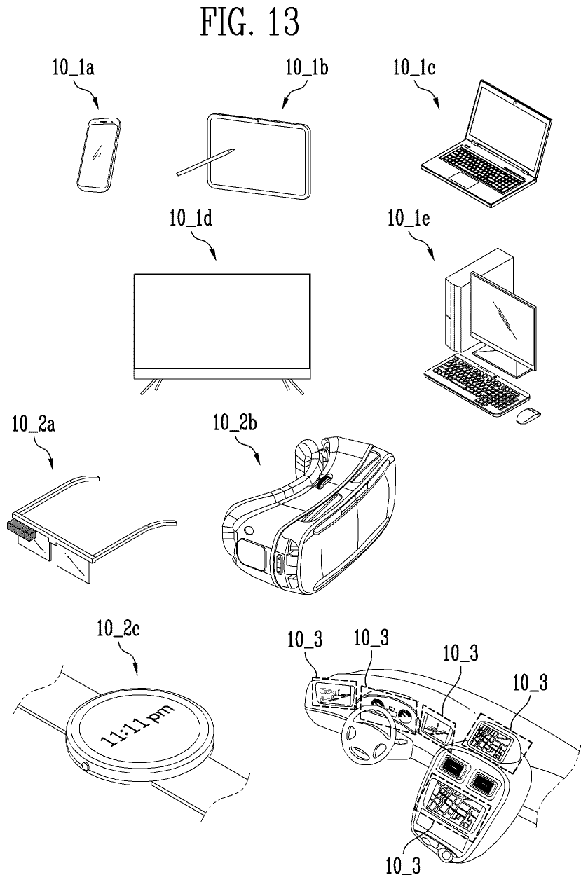

FIG. 13 shows schematic views of various embodiments of an electronic device.

Referring to FIG. 13, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

Although certain embodiments and implementations have been described herein, other embodiments and modifications will be apparent from this description. Accordingly, the inventive concept is not limited to the embodiments, but rather to the broader scope of the presented claims and various obvious modifications and equivalent arrangements.

What is claimed is:

1. A display device comprising:
a display panel including a plurality of pixels; and
a display driver configured to display an image on the display panel in units of frame periods, to supply data signals corresponding to the image to the display panel during a display period of the frame period to display the image, and to not display the image during a blank period of the frame period,
wherein during a blank period of one of the frame periods, the display driver is configured to supply data signals including at least one data drop waveform to the display panel.

2. The display device of claim 1, wherein
each of the data drop waveforms corresponds to a waveform that rises in a step shape and then vertically falls.

3. The display device of claim 2, wherein
a maximum voltage value of each of the data drop waveforms is greater than voltage values of the data signals supplied to the display panel during the display period of the one of the frame periods.

4. The display device of claim 2, wherein
a number of the data drop waveforms is determined by a length of the blank period of the one of the frame periods.

5. The display device of claim 4, wherein
the number of the data drop waveforms increases as the length of the blank period in the one of the frame periods increases.

6. The display device of claim 2, wherein
an interval between the data drop waveforms is constant.

7. The display device of claim 2, wherein
an interval between the data drop waveforms constantly increases as it moves away from the display period of the one of the frame periods.

8. The display device of claim 2, wherein
during the one of the frame periods, the later the data drop waveform is supplied to the display panel, the higher the maximum voltage value of the data drop waveform is.

9. The display device of claim 2, wherein
during the one of the frame periods, the later the data drop waveform is supplied to the display panel, the lower the maximum voltage value of the data drop waveform is.

10. The display device of claim 2, wherein
during the one of the frame periods, the lower a grayscale of the image displayed on the display panel, the higher the maximum voltage value of the data drop waveforms.

11. The display device of claim 1, wherein
a length of the display period in which the display driver is driven at a first driving frequency and a length of the display period in which the display driver is driven at a second driving frequency greater than the first driving frequency are equal.

12. The display device of claim 1, wherein
a length of the display period in which the display driver is driven at a first driving frequency is longer than a length of the display period in which the display driver is driven at a second driving frequency greater than the first driving frequency.

13. A driving method of a display device that includes a display panel including a plurality of pixels and a display driver configured to display an image on the display panel in units of frame periods, comprising:
supplying data signals corresponding to the image to the display panel during a display period of one frame period to display the image; and
supplying data signals including at least one data drop waveform to the display panel during a blank period of the one frame period.

14. The driving method of the display device of claim 13, wherein
each of the data drop waveforms corresponds to a waveform that rises in a step shape and then vertically falls.

15. The driving method of the display device of claim 14, wherein
a maximum voltage value of each of the data drop waveforms is greater than voltage values of the data signals supplied to the display panel during the display period of the one frame period.

16. The driving method of the display device of claim 14, wherein
a number of the data drop waveforms is determined by a length of the blank period of the one frame period.

17. The driving method of the display device of claim 14, wherein
an interval between the data drop waveforms is constant.

18. The driving method of the display device of claim 14, wherein
an interval between the data drop waveforms constantly increases as it moves away from the display period of the one frame period.

19. The driving method of the display device of claim 14, wherein
during the one frame period, the later the data drop waveform is supplied to the display panel, the higher the maximum voltage value of the data drop waveform is.

20. An electronic device, comprising:
a processor to provide input image data; and
a display device to display an image based on the input image data,
the display device comprising:
a display panel including a plurality of pixels; and
a display driver configured to display an image on the display panel in units of frame periods, to supply data signals corresponding to the image to the display panel during a display period of the frame period to display the image, and to not display the image during a blank period of the frame period,
wherein during a blank period of one of the frame periods, the display driver is configured to supply data signals including at least one data drop waveform to the display panel.
